(19) United States
(12) Patent Application Publication
(10) Pub. No.: US 2016/0139013 A1
(43) Pub. Date: May 19, 2016

(54) A METHOD AND APPARATUS FOR DILUTION OF AEROSOLS

(71) Applicant: PARTICLE MEASURING SYSTEMS, INC., Boulder, CO (US)

(72) Inventor: Boris Zachar GORBUNOV, Kent (GB)

(73) Assignee: PARTICLE MEASURING SYSTEMS, INC., Boulder, CO (US)

(21) Appl. No.: 14/899,870

(22) PCT Filed: Jun. 20, 2014
(86) PCT No.: PCT/EP2014/063059

§ 371 Date: Dec. 18, 2015

(30) Foreign Application Priority Data
Jun. 21, 2013 (GB) 1311097.8

(51) Int. Cl. G01N 1/38; G01N 15/06; G01N 1/22

(52) U.S. Cl. CPC G01N 1/38; G01N 1/2202; G01N 15/06

(57) ABSTRACT

The invention provides an apparatus set up for diluting aerosols; the apparatus comprising:
(i) a dilution chamber (1);
   (ii) an aerosol inlet (2) on one side of the dilution chamber for admitting an aerosol into the dilution chamber;
   (iii) an aerosol outlet (3) on the same or another side of the dilution chamber through which diluted aerosol particles can leave the dilution chamber;
   (iv) a diluent gas inlet (4) for admitting into the chamber a diluent gas;
   (v) a diluent gas outlet (5) through which diluent gas can leave the dilution chamber;
   (vi) a gas flow maintenance system (6) that provides circulation of the diluent gas through the dilution chamber; and
   (vii) means for determining the extent of dilution of the aerosol leaving the aerosol outlet.

The invention also provides methods of diluting and counting aerosol particles using the apparatus of the invention.

This invention relates to a method and apparatus for diluting aerosols. More particularly, the invention relates to a method and apparatus for diluting an aerosol flow having a high particle concentration to improve the accuracy of measurements taken on the aerosol flow. The invention also provides the use of a diluter apparatus of the invention in combination with a Condensation Particle Counter (CPC), Scanning Mobility Particle Sizer (SMPS), Fast Mobility Particle Sizer (FMPS) or an Optical Particle Counter (OPC) for measuring aerosols containing high concentrations of particles.

### BACKGROUND OF THE INVENTION

There is currently a great deal of concern about the health effects of nano-particles and micro-particles emitted unintentionally into the air. For example, a considerable increase in respiratory illness and allergies in the UK in recent years has been associated in part with particles emitted by diesel engines and other combustion processes. Whilst the main focus has been on diesel emissions, attention is turning to other potential sources such as power generation using fossil fuels, incineration, nuclear power generation and aircraft emissions. All heavy industries involving processes emitting fumes have potential problems with the emission of aerosol particles. Such processes include smelting, firing, glass manufacture, welding, soldering, nuclear power generation and incineration. There is also concern amongst consumer companies that use of enzymes in washing powders, powder coatings and fibres used in disposable nappies and other products could cause problems. In addition, the US EPA is becoming increasingly concerned about gasoline engine emissions.

Nano-particles and nano-objects are known to produce toxic effects. For example, they can cross the blood-brain barrier in humans, and gold nano-particles can move across the placenta from mother to foetus. Early studies with PTFE (polytetrafluoroethylene) particles around 20 nm in diameter showed that airborne concentrations of a supposedly inert insoluble material lower than 50 μg/m³ could be fatal to rats.

In addition to concerns from a health perspective, the elimination or control of airborne particles is important in maintaining standards in the many thousands of clean rooms in the micro-electronics, pharmaceutical, medical, laser, and fibre optics industries.

Small particles can be classified as shown in Table 1 below.

TABLE 1

| | Aerodynamic Equivalent Particle Size |
|---|---|
| Term | Range (dp = particle size) |
| Dust | dp > 10 μm |
| Coarse particles | 2.5 μm < dp < 10 μm |
| Fine particles | 100 nm < dp < 2.5 μm |
| Nano-particles or ultrafine particles | 1 nm < dp < 100 nm |

The term “nano-particles” is used to refer to particles having an aerodynamic particle size in the range from 1 nm to 0.1 μm.

For spherical particles, the aerodynamic particle size is the geometric diameter of the particle. Real particles in the air often have complicated shapes. For non-spherical particles, the term “diameter” is not strictly applicable. For example, a flake or a fibre has different dimensions in different directions. Particles of identical shape can be composed of different chemical substances and have different densities. The differences in shape and density cause considerable confusion in defining particle size.

The terms “aerodynamic particle size” or “aerodynamic diameter” are therefore used in order to provide a single parameter for describing real non-spherical particles having arbitrary shapes and densities. As used herein, the term “aerodynamic diameter” is the diameter of a spherical particle having a density of 1g/cm³ that has the same inertial property (terminal settling velocity) in the air (at standard temperature and pressure) as the particle of interest. Inertial sampling instruments such as cascade impactors enable the aerodynamic diameter to be determined. The term “aerodynamic diameter” is convenient for all particles including clusters and aggregates of any forms and density. However, it is not a true geometric size because non-spherical particles usually have a lower terminal settling velocity than spherical particles. Another convenient equivalent diameter is the diffusion diameter or thermodynamic diameter which is defined as a sphere of 1 g/cm³ density that has the same diffusivity in air as a particle of interest.

The investigation and monitoring of aerosol particles in the atmosphere has been hampered by a shortage of instruments which can measure in the wide particle size range but which are sufficiently inexpensive, robust and convenient to be used on a widespread basis.

Instruments for measuring and selecting aerosol particles can be based upon the electrical mobility of the particles; see for example: Flagan, R. C. (1998): History of electrical aerosol measurements, Aerosol Sci. Technol., 28(4), pp.301-380. One such instrument is a Differential Mobility Particle Sizer (DMPS) which can be used to determine the size distribution of particles in an aerosol. A DMPS consists of a Differential Mobility Analyzer (DMA), which transmits only particles with a certain size, and a Condensation Particle Counter (CPC), which counts the particles.

Widely used devices for counting particles in an aerosol are Optical Particle Counters (OPC) and Condensation Particle Counters (CPC). Both types of device make use of optical detection based on light-scattering: the OPC detects particles by direct light scattering from the particles while the CPC detects particles by first increasing the apparent size of the particles by condensing a vapour on to them particle to form droplets which are then detected optically by light scattering or other techniques, see for example EP1757921. An OPC is generally used for the counting of particles greater than 0.1 μm in particle diameter. Smaller particles require enlargement before counting and typically a CPC is used to increase the apparent size of the particles before counting. Condensation Particle Counters can be used to detect and count particles as small as 0.002 μm in diameter.

Both the CPC and the OPC have certain inherent limits on the concentrations of particles that they can detect and count; see for example EP1757921. The count rate limit of a particle counter is exceeded when particles are passing through the light beam at too rapid a rate for the particles to be counted reliably by the detecting and counting circuitry. Problems arise when more than one particle is present in the optical view volume of the detector causing light scattering from two or more particles to appear as one, leading to losses in particle counts, see FIG. 1. The concentration threshold at which this occurs is known as the “coincidence counting limit” and, for high accuracy measurements, this limit should not be exceeded.

Because of the adverse health effects of small particles emitted by diesel and spark ignition engines and other combustion sources, CPC is becoming increasingly important as a characterization instrument for engine exhaust measurements.

Exhaust emissions from vehicles are currently regulated in the USA by the Federal Government and therefore must not exceed predetermined contaminant levels as set forth, for example, within Title 40, Chapter 1 of the Code of Federal Regulations, Section 86, Subpart C.

In order to obtain reliable results, it is often necessary to dilute exhaust aerosols so that the concentrations of particles in the aerosol are below a certain level. One system for achieving such a dilution is disclosed in U.S. Pat. No. 5,058,440.

U.S. Pat. No. 6,729,195 discloses a sampling system that has a plurality of diluters arranged in a serial array along an axis. The system includes a source of gas fluidically connected to the plurality of serially arranged diluters so as to supply a gas stream into each one of the plurality of serially arranged diluters in a serial manner; a source of dilution air fluidically connected to each one of the plurality of serially arranged diluters so as to supply dilution air into each one of the plurality of serially arranged diluters such that the dilution air is supplied into the gas stream present within each one of the plurality of serially arranged diluters so as to progressively dilute the gas stream as the gas stream flows through the plurality of serially arranged diluters; and sampling apparatus fluidically connected to each one of the plurality of serially arranged diluters for obtaining the analyzing a sample of the diluted gas stream present within each one of the plurality of serially arranged diluters.

EP 1757921 discloses an apparatus for measurement of aerosols containing high concentrations of particles, the apparatus comprising a diluter for diluting the concentration of particles in a sample aerosol stream to form a diluted aerosol stream, and a sensor for detecting the particles in the diluted aerosol stream by vapour condensation, droplet growth and optical detection. The apparatus may be housed in a common housing along with any associated electronics for operating the apparatus and components such as pumps and filters. The diluter includes an input for an aerosol stream having an initial particle concentration, and a dilution stream. The aerosol stream and the dilution stream flow through a restriction which is sized such that turbulent flow is created so that the dilution stream and the aerosol stream are mixed to produce a diluted aerosol stream. The dilution stream is formed by drawing a portion from the diluted aerosol stream and filtering the portion to produce clean air that is mixed with the aerosol stream upstream from the restriction.

In order to extend the dynamic range of some instruments such as CPCs, a photometric mode is often used. In the photometric mode, light scattering from a plurality of droplets illuminated by the light beam is measured by an optical detector and used as a measure of droplet concentration. For example, in a commercial instrument (the Model 3022A CPC from TSI, Inc.) the photometric mode is used and, in this instrument, aerosols up to ˜10⁴ particles per cm³ are measured by single particle counting, while the photometric mode is used for higher concentrations up to 10⁷ particles per cm³.

It is known that light scattering from aerosol particles depends on droplet size, droplet material refraction index and droplet concentration. Therefore, the photometric mode is less accurate than the single particle counting mode. In the photometric mode, a small variation in droplet size due to variation in vapour saturation, humidity and condensation temperature can cause the droplet size or droplet chemical composition to change, giving rise to different instrument readings even if the aerosol concentration remains the same. It has been shown by comparison of several CPCs that differences as much as 60% or more in the measured aerosol concentrations can occur, see e.g. “Performance Evaluation of a Recently Developed Water-Based Condensation Particle Counter,” S. Biswas, P. M. Fine, M. D. Geller, S. V. Hering and C. Sioutas, Aerosol Science and Technology, 39, pp. 419-427. Thus, the photometric mode can contribute significantly to the frequently observed discrepancies in measured data.

A rotating disc diluter for fluid flows is described in U.S. Pat. No. 8,434,512 and comprises a rotatable rotary element carrying surface-accessible transfer volumes, which along their common path of movement, alternately glide over feed and discharge ports for an undiluted fluid flow on the one hand and for a dilution fluid flow on the other hand. For the simple widening of the usable dilution rate range, the rotary element has at least two rows of transfer volumes on different paths of movement, the associated feed ports of which for the undiluted fluid flow and/or for the dilution fluid flow can be separately controlled. Such arrangements, which are also referred to as carousel diluters (see J. of Aerosol Science, 1997, 28, pp. 1049-1055), are used for taking measurements when a dilution rate range is required to be as large as possible. However, such devices are expensive, noisy and have a relatively high power consumption.

There are several commercial diluters on the market. The Aerosol Diluter Model 3302A (TSI, Inc.) uses a closed system of operation. It isolates a small sample of particles in an aerosol flow and reunites it with filtered “clean” gas from the same original aerosol. It has two standard dilution ratios: 100:1 and 20:1 and rather large dimensions (L×W×H is 28 cm×37 cm×22 cm) as well as being relatively heavy (5.9 kg). This diluter is not designed for use with portable instruments such as a CPC or SMPS. In addition, a drawback with such diluters is that clogging of the filter may affect the dilution rate.

Another similar diluter is the TDA-D device from ATI, Inc. This device was designed for the specialized needs of the high efficiency particulate (HEPA) filter testing industry. The TDA-D Series aerosol diluters enhance the effectiveness of optical particle counters by diluting the upstream concentration of aerosol to measurable levels. Although the weight of this device is only 3.0kg, it is larger than the TSI 3302A instrument and has dimensions of 15.5 cm×8.3 cm×55.9 cm.

A general problem with known diluter devices is that they tend to be rather large, heavy and are often expensive. In general they are not designed to be used with or within a portable instrument such as a portable SMPS or CPC.

At present, therefore, there remains a need for an apparatus and method for diluting aerosols which avoids or minimises the aforementioned problems and which is applicable to a portable SMPS or CPC device that can be used to dilute aerosols over a wide range of particle number concentrations.

### SUMMARY OF THE INVENTION

The present invention sets out to provide an apparatus and a method for aerosol particle dilution as well as improve characterisation of aerosols that can be used with a portable CPC, OPC, SMPS and other apparatus in a wide range of particle concentrations.

In a first aspect, the invention provides an apparatus set up for diluting aerosols; the apparatus comprising:

(i) a dilution chamber;

(ii) an aerosol inlet on one side of the dilution chamber for admitting an aerosol into the dilution chamber;

(iii) an aerosol outlet on the same or another side of the dilution chamber through which diluted aerosol particles can leave the dilution chamber;

(iv) a diluent gas inlet for admitting into the chamber a diluent gas;

(v) a diluent gas outlet through which diluent gas can leave the dilution chamber;

(vi) a gas flow maintenance system that provides circulation of the diluent gas through the dilution chamber; and

(vii) means for determining the extent of dilution of the aerosol leaving the aerosol outlet.

In use, a sample of an aerosol is introduced into the aerosol inlet and is mixed with a diluent gas introduced through the diluent gas inlet. The aerosol and diluent gas mix and a proportion of the resulting diluted aerosol is drawn off through the aerosol outlet. The remainder of the diluted aerosol will exit the dilution chamber through the diluent gas outlet.

The apparatus is calibrated by introducing an aerosol of known particle concentration into the aerosol outlet and then measuring the number of particles in the diluted aerosol drawn off through the aerosol outlet. In this way, a calibration ratio can be determined which can be used to calculate the degree of dilution of an aerosol of unknown particle concentration.

Thus, the apparatus can be used to dilute an aerosol to a known and/or predetermined extent. The apparatus can be calibrated first and the operating parameters set to provide a predetermined extent of dilution of an aerosol. Alternatively, or additionally, one or more calibration measurements can be taken after the dilution of an aerosol of unknown particle concentration.

The apparatus will contain an electronic processer which controls the actions of the apparatus and has a data processing capability so that it can calculate dilution ratios and true particle concentrations from measured (observed) particle concentrations.

In one embodiment, the invention provides an apparatus as hereinbefore defined which is programmed to function as a diluter of aerosols and to calculate true particle concentrations from observed particle concentrations obtained from diluted aerosols.

The diluent gas can be any gas that does not react to any significant extent with the particles in the aerosol. For example, the diluent gas can be air. Alternatively, it can be, for example, nitrogen. In certain cases, the diluent gas could be an inert gas such as argon.

The diluent gas entering the dilution chamber through the diluent gas inlet is typically substantially particle free, or at least substantially free of particles of a size that can be detected by a particle counter used with the apparatus.

In one embodiment, the diluent gas contains substantially no particles of a size greater than or equal to 0.002 μm in diameter (aerodynamic diameter).

Accordingly, the diluent gas may be filtered before entering the dilution chamber, for example though a High-Efficiency Particulate Air (HEPA) filter.

The apparatus can comprise display means (viii) configured to display at least one parameter indicative of the extent of dilution of the aerosol leaving the aerosol outlet.

The aerosol inlet and aerosol outlet can be on the same side of the dilution chamber or on different sides.

In one embodiment, the aerosol inlet and aerosol outlet are on the same side of the dilution chamber.

In another embodiment, the aerosol inlet and aerosol outlet are on adjacent sides of the dilution chamber.

In a further embodiment, the aerosol inlet and aerosol outlet are on opposite sides of the dilution chamber.

The apparatus of the invention has at least one of each of the aerosol inlet and aerosol outlet.

In one embodiment, the apparatus has only one aerosol inlet and only one aerosol outlet.

In another embodiment, the apparatus has more than one aerosol inlet and/or more than one aerosol outlet.

The apparatus of the invention has at least one of each of the diluent gas inlet and diluent gas outlet.

In one embodiment, the apparatus has only one diluent gas inlet and only one diluent gas outlet.

In another embodiment, the apparatus has more than one diluent gas inlet and/or more than one diluent gas outlet.

In one particular embodiment, the apparatus has one of each of the aerosol inlet, aerosol outlet, diluent gas inlet and diluent gas outlet.

The dilution chamber is typically airtight; i.e. apart from the aerosol inlet, aerosol outlet, diluent gas inlet and diluent gas outlet. One or more, or all, of the inlets and outlets may be provided with a valve for controlling flow of gas/aerosol therethrough.

The apparatus comprises a gas flow maintenance system that provides circulation of the diluent gas through the dilution chamber. The gas flow maintenance system may comprise a pump; one or more filters for filtering diluent gas before it passes through the diluent gas inlet into the dilution chamber; and means for measuring and optionally displaying the flow rate of the diluent gas into or out of the dilution chamber.

The means for measuring the flow rate measuring may comprise a mass flow meter; or a throttle with a differential pressure meter; or any other flow rate quantifying means.

Accordingly, in one particular embodiment of the invention, the invention provides an apparatus set up for diluting aerosols, wherein the apparatus is as hereinbefore defined and comprises:
an airtight dilution chamber;
an aerosol inlet located at one side of the dilution chamber;
an aerosol outlet located at another side or the same side of the dilution chamber (preferably an adjacent side);
a diluent gas inlet and a diluent gas outlet;
a diluent gas air flow maintenance system pump;
an aerosol filter for removing particles prior to entry of diluent gas into the diluent gas inlet;
a flow rate measuring means;
a diluent gas flow rate control circuit; and
a diluent gas flow rate indicator.

In each of the foregoing aspects and embodiments of the invention, diluent gas from the diluent gas outlet may be recycled through the gas flow maintenance system, filtered to remove particles and reintroduced into the dilution chamber through the diluent gas inlet.

Filtration of the diluent gas may be carried out using a high efficiency HEPA filter.

The dilution chamber can be any one of a variety of different shapes. For example, it can be cylindrical or spherical, or may have a polygonal, circular or ellipsoidal cross section. The dilution chamber is typically of elongate form and the inlets may be located at one end of the elongate form and the outlets at the other end of the elongate form.

In one embodiment, a differential mobility analyser (DMA) column can be used as the dilution chamber. In this embodiment, the apparatus is typically set up so that the electrodes are at zero potential or at such a low potential that they do not have any significant effect on the movement of particles in the dilution chamber. An advantage of using a DMA column is that the DMA can be set up to operate in two modes, a first mode in which the apparatus functions as a conventional DMA and a second mode in which the DMA functions as a diluter. In the second (diluter) mode, the DMA is configured to provide (and optionally display) information about the dilution of the aerosol gas. A DMA configured to operate in two modes and be switchable from one mode to the other forms a further aspect of the invention.

A DMA column can be a part of a DMA or a part of an SMPS or FMPS.

In an alternative embodiment, the dilution chamber contains no electrodes and cannot function as a DMA.

The dilution chamber can contain one or more baffles, walls or partitions for separating or channelling flows of gases within the dilution chambers. For example, a partition wall may be disposed between the aerosol inlet and the diluent gas inlet so as to delay mixing of the aerosol with the diluent gas. Alternatively or additionally (preferably additionally), a partition wall may be disposed between the aerosol outlet and diluent gas outlet so as to separate the aerosol and diluent gas flows before they pass through their respective outlets.

The partition walls may be disposed, for example, adjacent the aerosol inlet and aerosol outlet respectively so that there is an unimpeded flow path for the diluent gas between the diluent gas inlet and the diluent gas outlet.

In each of the foregoing aspects and embodiments of the invention, it is advantageous to monitor the flow rate of the aerosol into and/or out of the dilution chamber and, accordingly, the apparatus typically comprises at least one flow rate meter for measuring aerosol flow rate.

The invention also provides methods of diluting aerosols.

Accordingly, in another aspect, the invention provides a method for diluting aerosols comprising:

(i) directing an aerosol containing a first particle concentration into a dilution chamber;

(ii) directing a diluent gas into the dilution chamber;

(iii) mixing the aerosol flow and the diluent gas in the dilution chamber to form a diluted aerosol of a lower particle concentration;

(iv) discharging part of the diluted aerosol from the dilution chamber through one outlet; and

(v) discharging the other part of the diluted aerosol from the dilution chamber through another outlet.

The part of the diluted aerosol discharged in step (iv) may be directed to waste (e.g. exhausted to atmosphere) or it may be recycled through a filter and pump and the resulting filtered gas being reused as diluent gas.

The part of the diluted aerosol discharged in step (v) may be directed for use. By the term “for use” is meant that the aerosol is subjected to a further processing step which is more than simply filtering and recycling or directing to waste. Thus, for example, the part of the diluted aerosol discharged in step (v) may be conveyed to an instrument or apparatus for further processing or measurement of the aerosol. More particularly, the diluted aerosol can be directed to a particle counter such as an OPC or CPC.

The flow rate of the aerosol flow entering the dilution chamber and the flow rate of the aerosol leaving the chamber for use (discharged in step(v)) may or may not be equal.

In one embodiment, the flow rate of the aerosol flow entering the dilution chamber and the flow rate of the aerosol leaving the chamber for use are approximately or exactly equal.

In another embodiment, the flow rate of the aerosol flow entering the dilution chamber and the flow rate of the aerosol leaving the chamber for use are unequal.

The method of the invention is preferably carried out using an apparatus of the invention as hereinbefore defined. Thus, for example, in step (i), the aerosol flow can be directed into the dilution chamber through the aerosol inlet of the apparatus of the invention and the diluent gas in step (ii) can be directed into the dilution chamber through the diluent gas inlet of the apparatus of the invention. Similarly, the part of the diluted aerosol discharged in step (iv) can be discharged through the diluent gas outlet of the apparatus of the invention and the dilute aerosol gas discharged in step (v) can be discharged through the aerosol outlet of the apparatus of the invention.

The methods of the invention as defined above or as set out below may make use of each of the embodiments and preferences described above in relation to the apparatus.

In another embodiment of the invention, there is provided a method for diluting aerosols comprising:

(i) directing an aerosol flow containing a first particle concentration into a closed volume dilution chamber;

(ii) directing a diluent gas into the dilution chamber;

(iii) mixing the aerosol flow and the diluent gas in the dilution chamber to form a diluted aerosol containing a lower particle concentration than the first particle concentration;

(iv) removing a part of the diluted aerosol and recycling the removed part of the aerosol by filtering and introducing the resulting filtered gas back to the dilution chamber thereby forming a circulation loop; and

(v) directing the other part of the diluted aerosol out of the dilution chamber for use, as hereinbefore defined.

Preferably, the above method makes use of an apparatus of the invention as defined above.

In each of the apparatus and method aspects and embodiments of the invention, the dimensions of the dilution chamber and the flow rates of the aerosol and diluent gas may be chosen as to provide turbulent conditions in the dilution chamber, thereby to bring about rapid mixing and dilution.

Alternatively, in each of the apparatus and method aspects and embodiments of the invention, the dimensions of the dilution chamber and the flow rates of the aerosol and diluent gas may be chosen as to provide laminar flow of the diluent gas through the dilution chamber

Accordingly, in another aspect of the invention there is provided a method for diluting aerosols comprising:

(i) directing an aerosol flow into an elongate closed volume dilution chamber from one side of the chamber;

(ii) directing a flow of diluent gas into the dilution chamber from the same side to provide a laminar flow of gas inside the said chamber;

(iii) allowing the aerosol flow and diluent gas to mix to give a diluted aerosol;

(iv) removing a part of the diluted aerosol from the dilution chamber at a location on a side opposite the said one side and recycling the removed part of the diluted aerosol by filtering it and introducing the filtered flow back into the dilution chamber, thereby forming a recirculation loop; and

(v) taking the other part of the diluted aerosol out of the dilution chamber at a location on a side opposite the said one side and directing the flow for use.

In the above process, the apparatus (typically an apparatus of the invention as hereinbefore defined) is configured and set up so as provide laminar flow of the diluent gas. A skilled person will readily be able to determine the conditions necessary for the gas flow inside the dilution chamber to be laminar.

The above process is carried out in an elongate chamber. Examples of an elongate dilution chamber are chambers having a circular cylindrical form and chambers having a polygonal (e.g. rectangular) or oval cross section.

In another aspect, the invention provides a method for diluting aerosols in an SMPS using a DMA column of the SMPS as a dilution chamber, the process comprising:

(i) directing an aerosol flow containing gas-entrained particles into the DMA column;

(ii) setting a sheath flow rate a predetermined value;

(iii) switching a potential difference between any electrodes in the DMA column to 0 or to a sufficiently low voltage that they have a negligible effect on aerosol particle movement;

(iv) allowing mixing of the sheath flow and the aerosol flow so as to dilute the aerosol flow;

(v) detecting and counting the particles in the diluted aerosol flow using a particle counting means forming part of the SMPS to give an observed particle concentration; and

(vi) correcting the observed particle concentration obtained from step (v) to give a true particle concentration by applying a dilution ratio determined (e.g. determined beforehand) by passing an aerosol containing a known concentration of particles through the SMPS.

In another aspect, the invention provides a method for counting aerosol particles using an SMPS, the method comprising:

(i) directing an aerosol flow into a DMA column of an SMPS with a sheath flow rate set at zero value;

(ii) switching a potential difference between electrodes in the DMA column to 0 or to a sufficiently low voltage that there is a negligible effect of the voltage on movement of particles in the aerosol; and

(iii) detecting and counting particles in the aerosol using a particle counting means forming part of the SMPS.

It should be appreciated that the DMA column can be of a rectangular or disc shape or any shape that enables the separation of charged particles to be achieved.

Using the DMA of an SMPS as a diluter enables the SMPS to be calibrated internally. In particular, it provides a way of calibrating the means for charging the aerosol particles in the SMPS. Using the DMA as a diluter is a considerable advantage in many applications, especially for aerosols of high concentrations or under conditions when use of a radioactive neutraliser or a corona charger is not very reliable, e.g. for agglomerate particles such as soot or for carbon nanotubes. Comparison of a directly measured aerosol particle number concentration with a value calculated from the size distribution will indicate if the instrument works correctly. In addition, the use of a CPC function with an SMPS enables efficiency to be increased and provides a less expensive solution for customers than the conventional use of two different instruments. Switching of the sheath flow rate to zero value can be done using the on-board software without need to set up or re-set up hardware.

In another aspect of the invention, there is provided a method for extending the concentration range of aerosol particles of a CPC comprising 5 stages:
(i) at a first stage, measuring aerosol particle number concentration N at the dilution flow rate Q_{dl}=0;
(ii) at a second stage, the obtained value N is compared with a predetermined concentration N_{c} and if N<N_{c} than the concentration value is exported to an output device;
(iii) if N>N_{c} then the dilution flow rate is changed from Q_{dl}=0 to a predetermined value Q_{d} thereby diluting the aerosol;
(iv) at stage 4 a concentration measurement is taken of the diluted aerosol;
(v) at a fifth stage (e.g. finally), the aerosol particle number concentration N measured at the dilution flow rate Q_{dl}=Q_{d} is exported to an output device.

It should be appreciated that this method can be applied to other instruments and devices where there is a need to reduce the aerosol particle number concentration.

Other aspects and embodiments of the invention will apparent from the accompanying drawings FIGS. 1 to 8 and the specific embodiments described below.

### BRIEF DESCRIPTION OF THE DRAWINGS

FIG. 1 is a schematic diagram of a measured aerosol particle number concentration N-measured vs. the true aerosol particle number concentration N-true.

FIG. 2 is a schematic cross-sectional view of a diluting apparatus according to a first embodiment of the invention.

FIG. 3 is a schematic cross-sectional view of an apparatus according to a second embodiment of the invention.

FIG. 4 is a schematic cross-sectional view of an apparatus according to a third embodiment of the invention.

FIG. 5 is a schematic cross-sectional view of an apparatus according to a fourth embodiment of the invention.

FIG. 6 is a flow chart diagram showing sequential stages of a method for measuring higher concentration of aerosol particle according to one aspect of the invention.

FIG. 7 is a graph showing the relationship between the dilution ratio Dr and the flow rate Qcl of a particle-free clean diluent gas for an apparatus set up according to one embodiment of the invention.

FIG. 8 is a graph showing the relationship between the dilution ratio Dr and the flow rate Qcl of a particle-free clean diluent gas for an apparatus set up according to another embodiment of the invention.

### DETAILED DESCRIPTION OF THE INVENTION

The invention will now be illustrated in greater detail, but not limited, by reference to the accompanying drawings 1 to 8 and the following non-limiting examples.

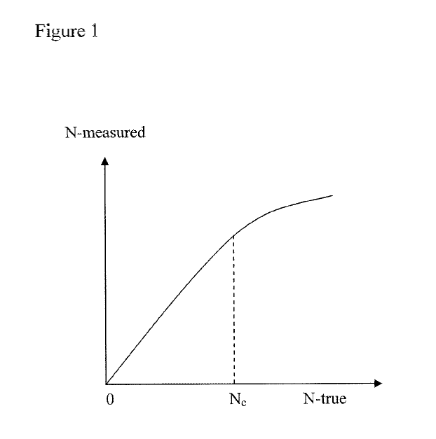

FIG. 1 is a schematic diagram of a measured aerosol particle number concentration “N-measured” vs. the true aerosol particle number concentration “N-true”. The particle number concentration follows the true concentration if N-measured <N_{c}, where N_{c} is the coincidence counting limit. In this range, there is a simple linear 1:1 relationship between the true and the measured concentrations. However, if the measured concentration is greater than the coincidence counting limit (N-measured >N_{c}), then the curve becomes non-linear and N-measured is less than N-true. This is a result of the coincidence counting when two or more particles scatter light at the same time. Therefore, for concentrations greater than N_{c}, dilution of the aerosol is necessary in order to provide reliable concentration measurements.

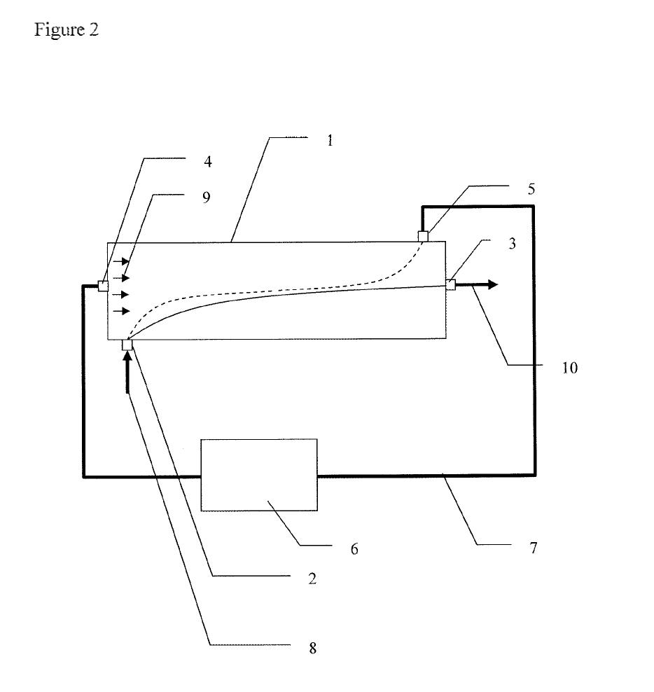

FIG. 2 shows a schematic cross-sectional view of an aerosol diluting apparatus according to a first embodiment of the invention. The invention provides an apparatus comprising:
a dilution chamber 1;
an aerosol inlet 2 located on one side of the dilution chamber 1;
an aerosol outlet 3 located on another side (or it could be the same side) of the dilution chamber 1;
a diluent gas inlet 4 for supplying clean gas containing no detectable particles, and a diluent gas outlet 5 located in the walls of the chamber 1;
a diluent gas (e.g. air) flow maintenance system 6 that provides circulation of the diluent gas (e.g. air) via fluid conduit 7; and
a display or other flow rate indicator (not shown).

In use, an aerosol 8 containing a known concentration of particles is directed at a known flow rate through inlet 2 into the dilution chamber 1. In the dilution chamber 1, a flow of a diluent gas 9 (e.g. clean air containing no detectable levels of particles) is circulating at a known flow rate. This flow is generated by a flow maintaining system 6 that directs the flow into the chamber 1 via the inlet 4 and out of the chamber 1 via the outlet 5. As a result of interaction between the diluent gas flow and the aerosol flow, a complicated flow pattern develops and the aerosol particles are diluted with the diluent gas 9. A part of the resulted diluted aerosol flow 10 is extracted via outlet 3 and is directed to a CPC, OPC or any other device for counting or using the particles. By comparing the number of particles counted in the aerosol flow 10 with the particle concentration in the original aerosol flow 8 at different diluent gas flow rates Qcl, a dilution ratio Dᵣ can be obtained. Once the dilution ratio for the apparatus has been determined, aerosols of unknown particle concentration can then be passed through the diluter and the numbers of particles in the diluted aerosol flow from outlet 3 determined. The observed count can then be corrected to give a true count by applying the dilution ratio.

The dilution process is shown schematically by means of the two curved lines inside the chamber 1: the solid line represents a fraction of the particles directed to the aerosol outlet 3 and the dashed line indicates the other part of the aerosol particles that is extracted via outlet 5. The aerosol extracted through diluent outlet 5 is passed through the flow maintenance system 6, where it is filtered to remove the aerosol particles, and is then recycled back through the inlet 4 into the dilution chamber.

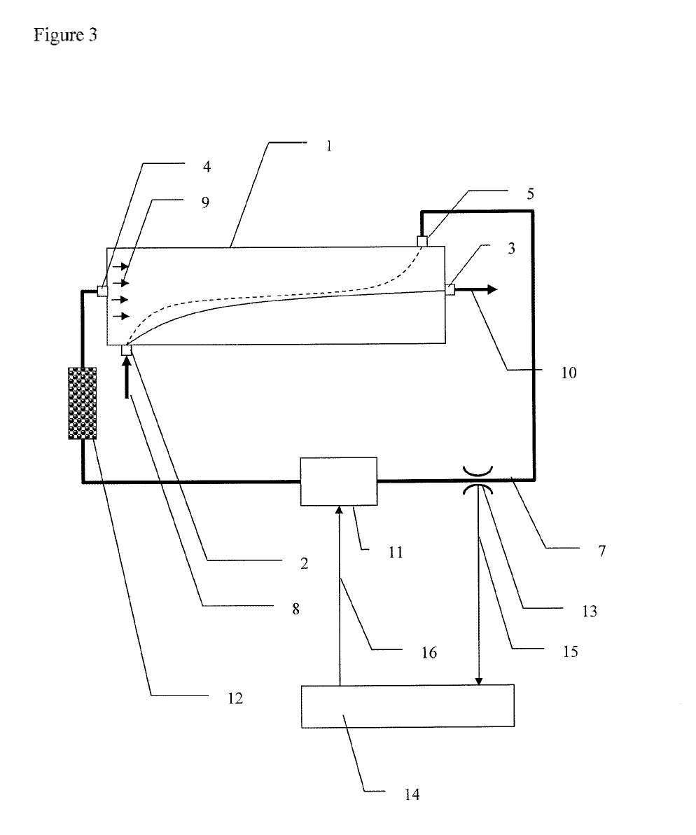

FIG. 3 shows an apparatus according to a second embodiment of the invention which comprises:
an airtight dilution chamber 1;
an aerosol inlet 2 located on one side of the dilution chamber 1;
an aerosol outlet 3 located on another (or the same) side of the dilution chamber 1 preferably adjacent the inlet 2 side;
a diluent gas inlet 4 for receiving clean diluent gas (e.g. air) and a diluent gas outlet 5;
a diluent gas flow maintenance system pump 11;
an aerosol filter 12;
a flow rate measuring means 13 (e.g. meter) in fluid communication 7 with the aerosol filter 12, the pump 11 and the dilution chamber 1;
a diluent gas flow rate control circuit 14 connected electrically via link 15 with the flow measuring means 13 and connected electrically via link 16 with the pump 11; and
a display or other diluent gas flow rate indicator.

The apparatus according to the second embodiment operates in a similar manner to the first embodiment of the invention. In use, a known flow rate of aerosol particles 8 is directed to the inlet 2 of the airtight dilution chamber 1. In the dilution chamber 1, a flow 9 of a diluent gas, e.g. air, containing no particles (a clean fluid) is circulating under the control of a pump 11 so that the flow enters the chamber 1 via the inlet 4 and exits the chamber 1 via the outlet 5. The pump 11 is controlled by the diluent gas air flow rate control circuit 14 which is linked to the flow measuring means 13 and the pump 11. As a result of interactions between the aerosol flow 8 and the diluent gas flow 9 a complicated flow pattern is developed and aerosol particles entering the chamber 1 are diluted with the diluent gas 9. A part of the diluted flow 10 is taken out via the outlet 3 for use with a CPC, OPC (or other device). The dilution process is schematically shown with two curved lines inside the chamber 1: the solid line represent a fraction of particles directed to the aerosol outlet 3 and the dashed line indicates the other part of the aerosol particles that are directed via the outlet 5 through a filter and back to the chamber 1 via the inlet 4 to form a circulation flow. In order to improve the performance of the apparatus, a high efficiency HEPA filter 12 can be used.

The dilution chamber 1 can be any of a variety of shapes: for example, it can be rectangular, cylindrical, spherical or ellipsoidal cross section, etc. A DMA column can be used as a dilution chamber 1, but with the electrodes set to zero potential or a potential insufficiently high to interfere with the mixing and dilution process.

If desired, a plurality of diluent gas 4, 5 or aerosol 2, 3 inlets/outlets can be provided in the walls of the diluter chamber 1.

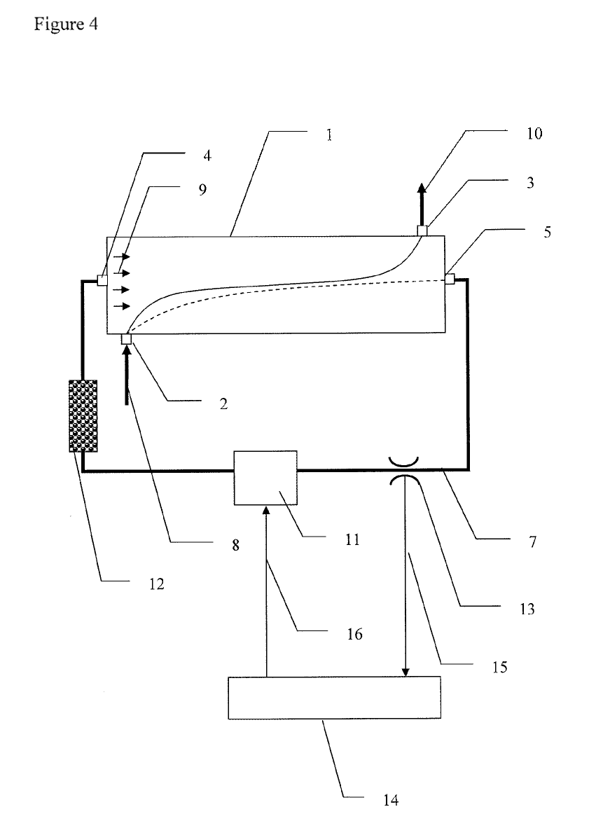

FIG. 4 illustrates an apparatus for diluting aerosols according to a third embodiment of the invention which comprises:
an airtight elongate dilution chamber 1;
an aerosol inlet 2 located on one side of the dilution chamber 1, e.g. the bottom of the chamber 1;
an aerosol outlet 3 located on the opposite side of the dilution chamber 1, e.g. the top of the dilution chamber 1;
an inlet 4 and an outlet 5 for diluent gas (e.g. clean air that contains no detectable levels of particles), the inlets and outlets being arranged in such a way that the diluent gas stream crosses the aerosol particle stream, e.g. from left to right;
a clean air flow maintenance system pump 11;
an aerosol filter 12;
a flow rate measuring means 13 in fluid communication by link 7 with the aerosol filter 12, the pump 11 and the dilution chamber 1;
a clean air flow rate control circuit 14 in electrical communication via link 15 with the flow measuring means 13 and in electrical communication via link 16 with the pump 11;
a display or other clean air flow rate indicator (not shown).

The apparatus according to the third embodiment operates as follows. A known flow rate of aerosol particles 8 is directed to the inlet 2 of the airtight dilution chamber 1 (FIG. 4). In the dilution chamber 1, a flow of a fluid, e.g. air, containing no particles (a clean fluid) 9 is circulating. This flow is generated by a pump 11 that directs the flow into the chamber 1 via the inlet 4 and out of the chamber 1 via the outlet 5. The pump 11 is controlled by the clean air flow rate control circuit 14 which is electrically connected via link 15 with the flow measuring means 13 and via link 16 with the pump 11. As a result of interactions between the predominantly axially flowing clean fluid 9 with the generally diagonally flowing aerosol flow 8, a part of the aerosol flow 8 is directed to the outlet 5 and the other part is directed to the aerosol outlet 3. Therefore, the number of aerosol particles reaching the outlet 3 is reduced and the fluid flow is topped up with the clean fluid 9. The part of the diluted aerosol 10 is extracted via outlet 3 for use with a CPC, OPC or any other device. The dilution process is schematically shown with two curved lines inside the chamber 1: the solid line represent the fraction of the aerosol particles directed to the aerosol outlet 3 and the dashed line indicates the fraction of the aerosol particles that exit the chamber through outlet 5 and are filtered and then recirculated back to the chamber 1 via the inlet 4.

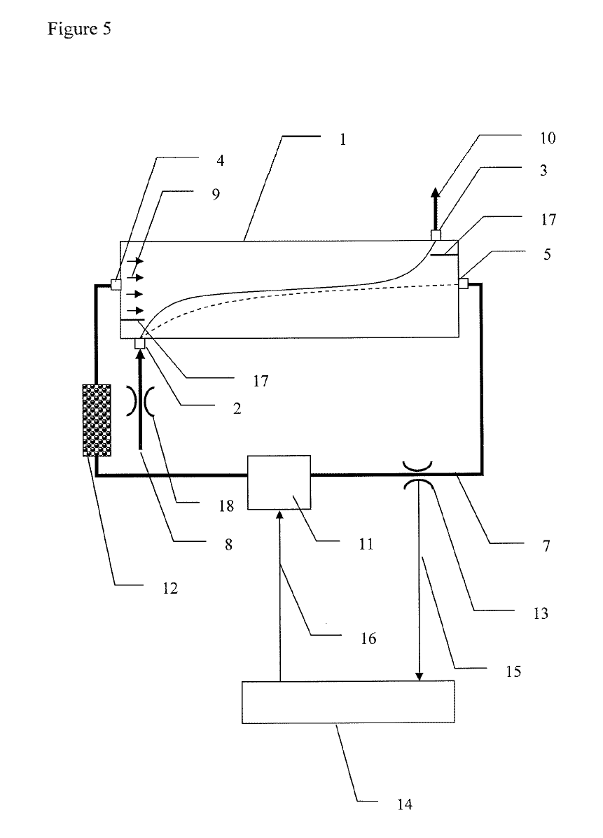

FIG. 5 illustrates a modified version of the apparatus of FIG. 4 in which partition walls 17 are included to provide initial separation of the aerosol and clean fluid flows. The partition walls reduce turbulent mixing between the aerosol flow and diluent gas near their respective inlets. An aerosol flow rate meter 18 is provided upstream of the aerosol inlet 2.

In each of the embodiments shown in FIGS. 3, 4 and 5, the flow rate measuring means 13 can be, for example, a mass flow meter, a throttle with a differential pressure meter or any other flow rate quantifying means. In general, is it advantageous for the apparatus to include an aerosol flow rate meter (e.g. as shown by the numeral 18 in FIG. 5).

In each of the embodiments illustrated, the flow rates of the aerosol flow 8 entering the dilution chamber 1 via the inlet 2 and the diluted aerosol flow leaving the chamber via the outlet 3 may or may not be equal to each other.

It should also be appreciated that the flow rates of the diluent gas 9 entering the dilution chamber 1 and leaving the chamber 1 may not be equal to each other.

However, preferably the flow rate of the clean fluid 9 entering the dilution chamber 1 via the inlet 4 is equal to the flow rate of the fluid leaving the dilution chamber 1 via the outlet 5.

In each of the embodiments of the invention shown in FIGS. 2 to 5, a DMA column of an SMPS can be used as the diluting chamber 1.

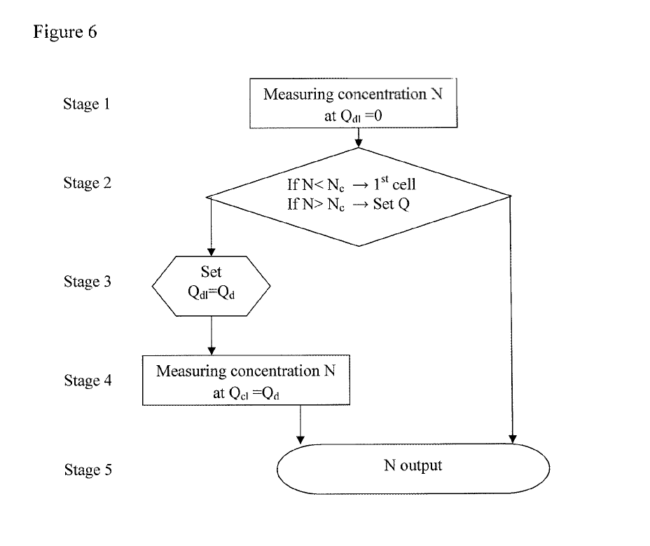

FIG. 6 is a flow chart illustrating the steps in a method for diluting aerosols according to the invention. The method comprises 5 stages, as follows:

At the first stage, the aerosol particle number concentration N is measured at a dilution flow rate Q_{dl}=0;

At the second stage, the measured value N is compared with a predetermined concentration value N_{c} (the coincidence counting limit). If N<N_{c} then the concentration value is accepted as a true value and is exported to an output device.

If N>N_{c} then the dilution flow rate is changed from Q_{dl}=0 to a predetermined value Q_{d} to produce a diluted aerosol in which N is expected to be lower than N_{c}.

At stage 4, a concentration measurement is taken of the diluted aerosol.

Finally, at stage 5 the aerosol particle number concentration N measured at the dilution flow rate Q_{dl}=Q_{d} is exported to an output device.

The observed particle concentration N can then be corrected to give the true particle concentration in the original aerosol sample by applying a dilution ratio Dᵣ determined earlier.

The following Examples describe several apparatuses making use of the principles described above.

### EXAMPLE 1

In one Example, a dilution device was built according to the second embodiment of the invention. The dilution chamber was machined out of Delrin® (Acetal Homopolymer) with internal dimensions 10×10×50 mm. A rotary vane pump of 4.7 l/min open face flow rate was used. A Balston HEPA aerosol filter and a rotameter were placed along the dilution chamber into a small plastic enclosure of 30×50×110 mm. The pump was powered with an external DC power supply.

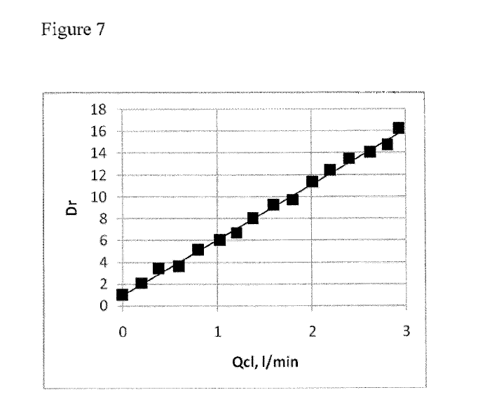

The dilution ratio of the device was determined with an NPC10 and NPS500 instruments (available from Particle Measuring Systems Inc. of Boulder, Colo., USA) at the aerosol flow rate 0.2 l/min. It was found that the dilution ratio Dr is almost a linear function of the clean air flow rate Qcl (FIG. 7). At Qcl=0 the dilution ratio is equal to 1. An increase of the Qcl up to almost 3 l/min leads to an increase in the dilution ratio of up to 16 times.

The dilution ratio was easy to control and to change by changing the diluent gas flow rate Qcl. The pressure drop across this diluter was practically zero. Clogging of the filter did not affect the dilution rate.

### EXAMPLE 2

In a second Example, a dilution device was built according to the third embodiment of the invention. The dilution chamber was machined out of aluminium with internal dimensions 10×8×60 mm. A rotary vane pump of 3 l/min open face flow rate was used. A Balston HEPA aerosol filter and a flow meter based on a differential pressure transducer and a throttle were placed along the dilution chamber into an aluminium enclosure of 35×50×100 mm. The pump was powered with an external DC power supply. Partition walls 5 mm long separating the aerosol and the clean air flows were inserted into the dilution chamber.

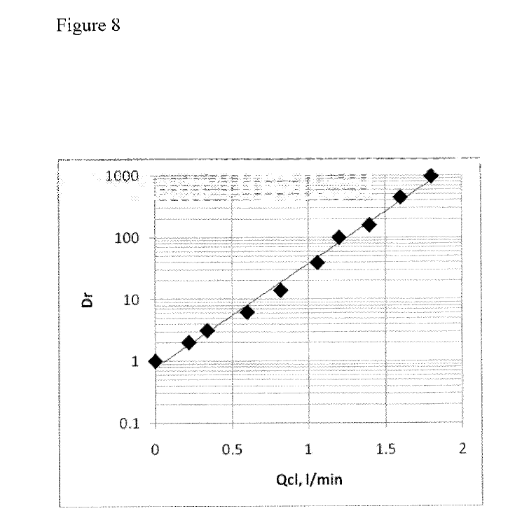

The dilution ratio of the device was determined with an NPC10 and NPS500 at the aerosol flow rate 0.2 l/min. It was observed that for this embodiment the dilution ratio is strongly influenced by the clean air flow rate Qcl (FIG. 8). At Qcl=0 the dilution ratio is equal to 1. An increase of the Qcl up to almost 1.8 l/min leads to an increase in the dilution ratio of up to 1000 times. The dilution rate was increasing exponentially with the clean air flow rate. This embodiment of the invention enables high dilution ratios to be obtained in a portable or even handheld enclosure.

The examples of the devices built according to embodiments of the invention demonstrate that it is possible to make an inexpensive portable to handheld sized apparatus which enables high concentration of aerosols to be diluted up to 1000 times. The devices demonstrated high stability and reliability of performance at various aerosol flow rates.

Equivalents

It will readily be apparent that numerous modifications and alterations may be made to the specific embodiments of the invention described above without departing from the principles underlying the invention. All such modifications and alterations are intended to be embraced by this application.

1. An apparatus set up for diluting aerosols; the apparatus comprising:
(i) a dilution chamber;
(ii) an aerosol inlet on one side of the dilution chamber for admitting an aerosol into the dilution chamber;
(iii) an aerosol outlet on the same or another side of the dilution chamber through which diluted aerosol particles can leave the dilution chamber;
(iv) a diluent gas inlet for admitting into the chamber a diluent gas;
(v) a diluent gas outlet through which diluent gas can leave the dilution chamber;
(vi) a gas flow maintenance system that provides circulation of the diluent gas through the dilution chamber; and
(vii) means for determining the extent of dilution of the aerosol leaving the aerosol outlet.

2. An apparatus according to claim 1 comprising an electronic processer which controls the apparatus and has a data processing capability so that it can calculate dilution ratios and true particle concentrations from measured (observed) particle concentrations.

3. An apparatus according to claim 2 which is programmed to function as a diluter of aerosols and to calculate true particle concentrations from observed particle concentrations obtained from diluted aerosols.

4. An apparatus according to claim 1 wherein the diluent gas is air.

5. An apparatus according to claim 1 which comprises a gas flow maintenance system that provides circulation of the diluent gas through the dilution chamber.

6. An apparatus according to claim 5 wherein the gas flow maintenance system comprises a pump; one or more filters for filtering diluent gas before it passes through the diluent gas inlet into the dilution chamber; and means for measuring and optionally displaying the flow rate of the diluent gas into or out of the dilution chamber.

7. An apparatus according to claim 1 comprising:
an airtight dilution chamber;
an aerosol inlet located at one side of the dilution chamber;
an aerosol outlet located at another side or the same side of the dilution chamber (preferably an adjacent side);
a diluent gas inlet and a diluent gas outlet;
a diluent gas air flow maintenance system pump;
an aerosol filter for removing particles prior to entry of diluent gas into the diluent gas inlet;
a flow rate measuring means;
a diluent gas flow rate control circuit; and
a diluent gas flow rate indicator.

8. An apparatus according to claim 1 wherein the diluent gas is filtered through a high efficiency HEPA filter before entering the dilution chamber.

9. An apparatus according to claim 1 wherein the dilution chamber is provided by a differential mobility analyser (DMA) column.

10. An apparatus according to claim 1 wherein the dilution chamber contains one or more baffles, walls or partitions for separating or channelling flows of gases within the dilution chambers.

11. A method of diluting aerosols comprising:
(i) directing an aerosol containing a first particle concentration into a dilution chamber;
(ii) directing a diluent gas into the dilution chamber;
(iii) mixing the aerosol flow and the diluent gas in the dilution chamber to form a diluted aerosol of a lower particle concentration;
(iv) discharging part of the diluted aerosol from the dilution chamber through one outlet; and
(v) discharging the other part of the diluted aerosol from the dilution chamber through another outlet.

12. A method of diluting aerosols comprising:
(i) directing an aerosol flow containing a first particle concentration into a closed volume dilution chamber;
(ii) directing a diluent gas into the dilution chamber;
(iii) mixing the aerosol flow and the diluent gas in the dilution chamber to form a diluted aerosol containing a lower particle concentration than the first particle concentration;
(iv) removing a part of the diluted aerosol and recycling the removed part of the aerosol by filtering and introducing the resulting filtered gas back to the dilution chamber thereby forming a circulation loop; and
(v) directing the other part of the diluted aerosol out of the dilution chamber for use.

13. A method of diluting aerosols comprising:
(i) directing an aerosol flow into an elongate closed volume dilution chamber from one side of the chamber;
(ii) directing a flow of diluent gas into the dilution chamber from the same side to provide a laminar flow of gas inside the said chamber;
(iii) allowing the aerosol flow and diluent gas to mix to give a diluted aerosol;
(iv) removing a part of the diluted aerosol from the dilution chamber at a location on a side opposite the said one side and recycling the removed part of the diluted aerosol by filtering it and introducing the filtered flow back into the dilution chamber, thereby forming a recirculation loop; and
(v) taking the other part of the diluted aerosol out of the dilution chamber at a location on a side opposite the said one side and directing the flow for use.

14. A method of diluting aerosols in an SMPS using a DMA column of the SMPS as a dilution chamber, the process comprising:
directing an aerosol flow containing gas-entrained particles into the DMA column;
(ii) setting a sheath flow rate a predetermined value;
(iii) switching a potential difference between any electrodes in the DMA column to 0 or to a sufficiently low voltage that they have a negligible effect on aerosol particle movement;
(iv) allowing mixing of the sheath flow and the aerosol flow so as to dilute the aerosol flow;
(v) detecting and counting the particles in the diluted aerosol flow using a particle counting means forming part of the SMPS to give an observed particle concentration; and
(vi) correcting the observed particle concentration obtained from step (v) to give a true particle concentration by applying a dilution ratio determined (e.g. determined beforehand) by passing an aerosol containing a known concentration of particles through the SMPS.

15. A method of counting aerosol particles using an SMPS, the method comprising:
(i) directing an aerosol flow into a DMA column of an SMPS with a sheath flow rate set at zero value;
(ii) switching a potential difference between electrodes in the DMA column to 0 or to a sufficiently low voltage that there is a negligible effect of the voltage on movement of particles in the aerosol; and
(iii) detecting and counting particles in the aerosol using a particle counting means forming part of the SMPS.

16. A method according to claim 11 which is carried out using an apparatus set up for diluting aerosols; the apparatus comprising:
(i) a dilution chamber;
(ii) an aerosol inlet on one side of the dilution chamber for admitting an aerosol into the dilution chamber;
(iii) an aerosol outlet on the same or another side of the dilution chamber through which diluted aerosol particles can leave the dilution chamber;
(iv) a diluent gas inlet for admitting into the chamber a diluent gas;
(v) a diluent gas outlet through which diluent gas can leave the dilution chamber;
(vi) a gas flow maintenance system that provides circulation of the diluent gas through the dilution chamber; and
(vii) means for determining the extent of dilution of the aerosol leaving the aerosol outlet.

17. A method of extending the concentration range of aerosol particles of a CPC comprising:
(i) at a first stage, measuring aerosol particle number concentration N at the dilution flow rate Q_{dl}=0;
at a second stage, the obtained value N is compared with a predetermined concentration N_{c} and if N<N_{c} than the concentration value is exported to an output device;
(iii) if N>N_{c} then the dilution flow rate is changed from Q_{dl}=0 to a predetermined value Q_{d} thereby diluting the aerosol;
(iv) at a fourth stage, a concentration measurement is taken of the diluted aerosol; and
(v) at a fifth stage, the aerosol particle number concentration N measured at the dilution flow rate Q_{dl}=Q_{d} is exported to an output device.

18. An apparatus according to claim 1 comprising one of each of the aerosol inlet, aerosol outlet, diluent gas inlet and diluent gas outlet.

19. An apparatus according to claim 1 wherein the dilution chamber is of elongate form and the aerosol inlet and diluent gas inlet are located at one end of the elongate form and the aerosol outlet and diluent gas outlet are located at the other end of the elongate form.

20. An apparatus according to claim 1 further comprising a partition wall disposed between the aerosol inlet and the diluent gas inlet so as to delay mixing of the aerosol with the diluent gas.
